(19) United States
(12) Patent Application Publication
(10) Pub. No.: US 2005/0198688 A1
(43) Pub. Date: Sep. 8, 2005

(54) System and method for digitally monitoring a cable plant

(76) Inventor: Thomas Kin Tak Fong, Redwood Shores, CA (US)

Correspondence Address: CARR & FERRELL LLP, 2200 GENG ROAD, PALO ALTO, CA, 94303, US

(21) Appl. No.: 11/069,575

(22) Filed: Feb. 28, 2005

Related U.S. Application Data
(63) Continuation of application No. 09/957,350, filed on Sep. 19, 2001, now abandoned.
(60) Provisional application No. 60/233,582, filed on Sep. 19, 2000.

(51) Int. Cl. H04N 7/173

(52) U.S. Cl. 725/129; 725/111; 725/105; 725/127; 725/107

(57) ABSTRACT

The present invention provides systems and methods for digitally certifying and monitoring a hybrid fiber coaxial (HFC) cable plant. The present invention may be used to automate the characterization of the upstream and/or downstream channels of the cable plant and provide a path for establishing a performance baseline for the cable plant. After certification of the plant, the present invention provides for monitoring of cable plant performance and the use of a performance baseline to provide warnings and alerts prior to system downtime. The present invention also discloses cable plant characterization and monitoring functions being provided from a single site to a plurality of remote cable plant operators.

### BACKGROUND

1. Field of the Invention

The present invention relates to certification and monitoring of a cable system or plant, and more particularly to certifying a hybrid fiber coaxial (HFC) cable plant and subsequently monitoring its performance.

2. Description of Related Art

In the early 1980's the benchmark for modem transmission speed over standard analog telephone lines was 300 bits per second (bps). This benchmark reached 56,000 bps (56 Kbps) in modems in 1998, essentially the limit of data transmission using “plain old telephone service” (POTS). However, with the broad acceptance of the World Wide Web (WWW) and associated applications such as electronic mail (e-mail), the sale and delivery of software via the WWW and other interactive data services, this 56 Kbps rate is becoming inadequate for widespread consumer use.

One non-POTS solution to the need for higher data throughput is a high-speed cable network, for example, an HFC cable television (CATV) network. However, CATV networks are generally constructed asymmetrically to maximize delivery of downstream data, that is, the signal flow from the cable plant headend downstream to users. Thus, a typical CATV network may have a hundred or more 6 megahertz (MHz) downstream channels and six 6 MHz upstream channels. Even where additional upstream channels are part of an original design or part of a system upgrade, high throughput or bandwidth for upstream transmissions is difficult to obtain and maintain. One reason for these difficulties with upstream data transmission is the physical plant layout. As a signal travels downstream through splitters on its way to all of the users, it is attenuated on the splitters' outputs. Any noise carried with the signal is also attenuated and the signal-to-noise ratio (SNR) remains unchanged. However, for upstream signal flow, the splitters' downstream outputs become upstream inputs, and incoming signals and noise are combined. Where a signal is present on only one input of a splitter but noise is present on both, the combined signal has a reduced SNR. As this combining process can take place many times, the SNR of an upstream signal is often reduced dramatically. This SNR reduction phenomena is referred to as noise funneling, which would have to be reduced or eliminated to maximize upstream data transmissions.

Another problem for CATV systems attempting to provide interactive data services is providing service uptime and reliability comparable to that of telephone services. However, a cable system operator, whether a single system operator or a multiple system operator (MSO), does not typically have the staff to address the new problems associated with this enhanced service uptime and reliability and the upstream data transmission capability needed for interactive data services. In addition to this shortage of maintenance personnel, the existing staff typically lacks experience in interactive data services and digital communications, as well as the required digital test equipment and new problem solving skills.

FIG. 1 is a simplified flow diagram of operational steps in currently known analog methods for certifying and maintaining a CATV cable plant 100A that is not a hybrid fiber coaxial (HFC) cable plant. A CATV cable plant capable of interactive data service and digital certification will be referred to as HFC CATV cable plant 100B. Beginning in step 110, a CATV cable plant 100A is newly constructed, upgraded or re-adjusted. In step 115, CATV cable plant 100A is tested until analog certification is established. If in step 115 the testing fails to establish certification, then the process returns on “No” path 112 to step 110 for additional adjustments and upgrades. The adjustments of step 110 and the tests of step 115 are repeated until CATV cable plant 100A is certified.

Analog testing methods are well known and will not be discussed in detail here, but it is useful to note that these methods are not readily automated. Rather, most analog testing methods used for cable plant certification require the physical presence of one or more maintenance personnel at each node of the cable plant to make the necessary measurements, evaluations and adjustments. When knowledge of the frequency response of a data channel is required for step 115 to grant analog certification to the plant, technicians must travel to each of several node locations and tap frequency analyzers into the cable to measure frequency responses over a range of settings. If a measurement indicates a problem, additional measurements are taken at other physical locations to determine the source of the problem. Such a process of measuring, changing location and re-measuring is time consuming and costly.

Once step 115 grants analog certification, the process follows “Yes” path 118 to step 120 where the plant is considered “certified” to begin commercial operation. However, these analog methods are not capable of fully testing the data transmissions flowing upstream.

While the certified plant is operating, it is essential to maintain plant performance standards and timely responses to user complaints. FIG. 1 depicts the plant maintenance process in step 121, step 131 and step 135. In step 121 a user complaint is received and correlated with similar complaints. In step 127, if the system has not received complaints sufficient enough to be reported for further action, then the process returns on “No” path 126 to step 121 to await additional complaints. If enough complaints have been received then the process follows “Yes” path 128 to step 131 for attention by a cable plant operator. For example, based upon those user complaints, a multiple system operator (MSO) may dispatch maintenance personnel to appropriate locations to correct the corresponding cable plant problem. Since the analog testing processes used for plant certification do not generally result in data baselines for the plant and its components, maintenance personnel must both diagnose and repair the problem, which is often not straightforward. For example, a user complaint received in step 121 can be as simple as “I can't access the Internet.” Thus, repairing the problem generally encompasses a diagnostic phase in step 135 where a technician visits the user's site to make various measurements and then determine the nature of the problem. After the diagnosis and repair of step 135, if recertification is necessary, the process follows “Yes” path 138 back to step 110 at the start. If recertification is not necessary, the process follows “No” path 132 back to step 121 to await additional complaints. At other times step 127 may determine that the operator will have to wait for additional user complaints to gain a better understanding of a problem before the first technician is dispatched. This waiting period is undesirable as it increases plant downtime for the user who registered the initial complaint.

Since CATV cable networks primarily provide television programming, most of the available bandwidth is dedicated to maximizing the number of channels available to users. Upstream bandwidth is therefore limited. Hence it would be desirable to maximize the usability of the available upstream data paths in CATV infrastructures. In addition, it would be desirable for the automated systems and methods that increase cable plant uptime and reliability to at least parallel those of the telephone companies. It would also be advantageous if these automated systems and methods could be employed to identify problems before they result in plant downtime, and to identify those portions of the cable plant that require upgrades to maintain high quality interactive data services. It would also be useful to identify the location of failed or about-to-fail equipment and thus enable rapid and inexpensive repairs. Finally, it would be valuable to have automated systems and methods that could monitor multiple cable plants from a single location.

### SUMMARY

The present invention provides digital certification and monitoring methods for a hybrid fiber coaxial (HFC) cable plant. The digital certification methods of some embodiments of the invention provide, among other things, a path for establishing a cable plant performance baseline or database and for after-certification monitoring of an HFC cable plant using the database. The monitoring methods include provisions such as warnings, messages, and alarms that anticipate problems with plant performance.

Some embodiments in accordance with the invention automate the characterization of an HFC cable plant. For example, in some embodiments a small number of cable modems (CM's) can be positioned at predetermined locations of a cable plant to provide information useful in plant characterization. Information about the radio frequency (RF) quality of the plant can be collected via the RF management information base (MIB) of the CM's and the cable modem termination system (CMTS). Typically, automated digital certification encompasses the collection of data over a day or more to identify any periodic effects on plant performance, such as those caused by daytime heating and nighttime cooling of components.

In some embodiments, digital certification of the cable plant is automated for both the upstream and downstream paths. Upstream certification generally includes characterization of the entire upstream band. Thus the certification process determines ingress or noise regions in each upstream band and uses this information to establish an optimal frequency allocation plan for each band. In addition, nonlinearity and noise versus the packet error rate (PER) are evaluated at the CMTS for data received from each of the several CM's over a spectrum of power levels and frequencies. This determines the dynamic range of each CM-to-CMTS upstream path, determines an optimal set of receive conditions, validates the alignment of reverse path amplifiers, and identifies the nature of any physical impairments.

Digital downstream certification is generally less complex as HFC cable plants have historically been designed to optimize downstream data flow. However, some embodiments of the invention evaluate and certify downstream channels with respect to SNR, tilt and channel distortion, and forward error correction rates. This identifies the most useable channels as well as any specific problems that limit channel usability.

A plant certification process, particularly of downstream channels, also uses analog methods and tools. For example, analog methods generally record analog data “snapshots” for a variety of channel characteristics such as hum, noise, carrier-to-noise ratio (CNR), and group delay.

Some embodiments of the invention employ the measurements of simple network management protocol (SNMP) agents and the management information bases (MIB's) of the smart components of the cable plant to create a certification database. Generally this data is collected throughout the certification process and provides a valuable baseline for the performance of the entire cable plant and its smart components over a period of one or more days. The advantage of having such a database lies in the ability to determine which of the measured parameters are useful for monitoring the HFC cable plant once the certification process is complete. For example, evaluation of PER data can result in the setting of one or more alarm levels to trigger a notification message regarding a predicted CM failure. Thus the notification allows for corrective action before the cable plant encounters downtime. In addition, as the monitoring methods of the invention link the monitored data to a specific component, use of such alarm levels for notification allows for the identification of a specific problem device. Collecting baseline data over time enables identifying various data trends that can be used to predict when a specific component's performance will begin to deteriorate. Thus an automated message can be dispatched that will allow for dynamic control of some “smart” cable plant components. In some embodiments of the invention, cable plant characterization and monitoring functions are provided by a single site remote from any one cable plant to a plurality of cable plant operators or MSO's.

These and other objects, features, and advantages of the present invention will be better understood with reference to the accompanying drawings among which given elements retain the same number.

### BRIEF DESCRIPTION OF THE DRAWINGS

FIG. 1 is a simplified flow diagram of operational steps to certify each node of a CATV cable plant with currently known analog testing methods and to maintain cable plant operation once analog certification is granted;

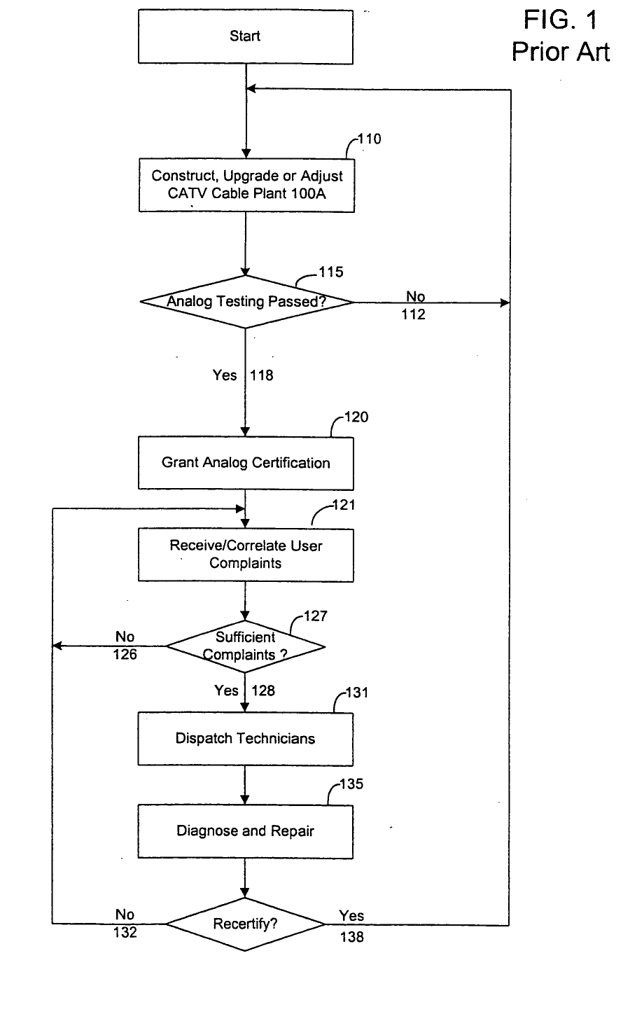

FIG. 2 is a simplified block diagram of a portion of an HFC CATV cable plant; and

FIG. 3 is a simplified flow diagram of operational steps to certify and monitor a HFC cable plant with analog and digital testing methodology according to the invention.

### DETAILED DESCRIPTION

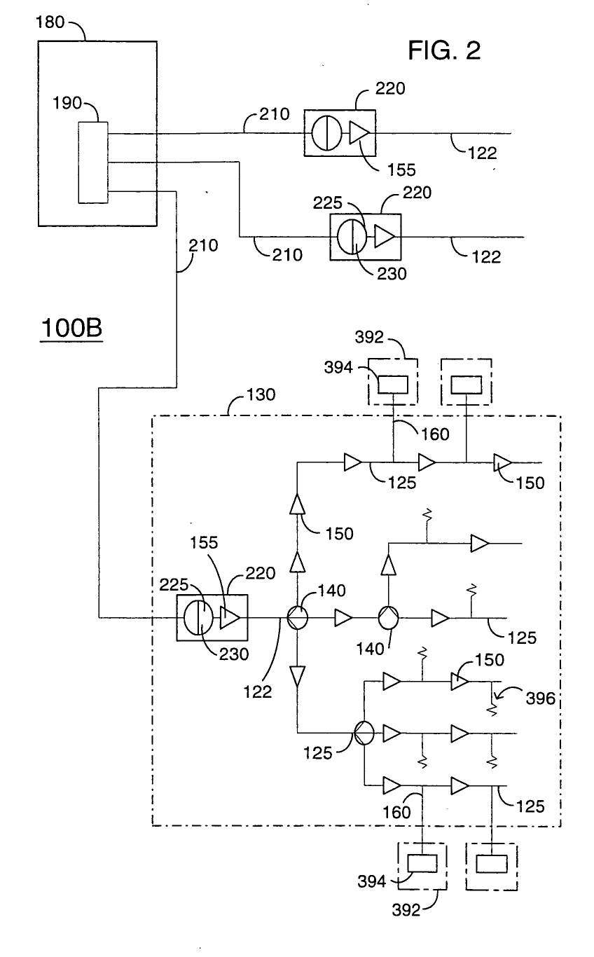

FIG. 2 is a block diagram illustrating the interconnectivity of some components of an HFC CATV cable plant 100B capable of interactive data service. This diagram is greatly simplified for ease of explanation. HFC cable plant 100B encompasses a headend 180 containing a cable modem termination system (CMTS) 190 coupled to one end of each of three fiber optic trunk cables 210. Each trunk cable 210 at its other end is coupled to a respective one of three optical network units 220. Although FIG. 2 shows three trunk cables 210 coupling to termination system 190, other configurations having a larger or small number of coupled trunk cables 210 are possible. Similarly, some embodiments in accordance with the invention have multiple termination systems 190.

Each optical network unit 220 couples one fiber optic trunk 210 to one coaxial cable run 122, and thus serves as the initiation point of local distribution networks, one of which, network 130, is shown in some detail for illustrative purposes. Exemplary distribution network 130 is a branched network of coaxial cable runs 125. At various points within distribution network 130, splitters 140 allow a single cable run 122 or 125 to branch into two or more cable runs 125. Each branched cable run 125 has a number of signal amplifiers 150 positioned appropriately for maintaining the sufficient signal strength being supplied to a user site 392. Where branched cable run 125 passes a user site 392, a cable tap 160 couples a cable modem 394 at user site 392 to cable run 125, providing cable modem 394 with interactive data service. Cable modems may be from various vendors, including but not limited to 3COM Cable Modem CMX, Thomson RCA DCM105, General Instrument SB3100, Sony CMR-1000, or Philips PD10D. The typical distance covered is a few hundred feet. Any Data Over Cable Service Interface Specification (DOCSIS) compliant cable modems would report power levels, signal-to-noise ratios, timing offsets, frame error counts, microreflection levels, and equalizer settings.

While not shown, each amplifier 150 is a bi-directional amplifier capable of amplifying both downstream and upstream signals. The signal level below which amplification is needed is −15 dBmV, where dBmV (decibels relative to one millivolt across 75 ohms) is a measure of RF power. The cable modem would not be able to receive an input beyond the range of −15 dBmV to +15 dBmV, otherwise known as the dynamic range.

The optical network unit 220 is a bi-directional optical fiber node. A fiber node provides the interface between a fiber trunking system and a coaxial distribution leg. Each optical network unit 220 includes a bi-directional amplifier 155, an optical receiver 225 for receiving the signal travelling downstream from optical trunk 210, and an optical transmitter 230 for transmitting the signal travelling upstream onto optical trunk 210 from cable run 120. At the simplest level, a fiber node may consist of a single optical receiver whose output is amplified to feed the downstream amplifier, and an upstream optical transmitter. The upstream optical transmitter's input is driven by the output of a combiner whose inputs are the upstream signals from all connected coaxial distribution legs.

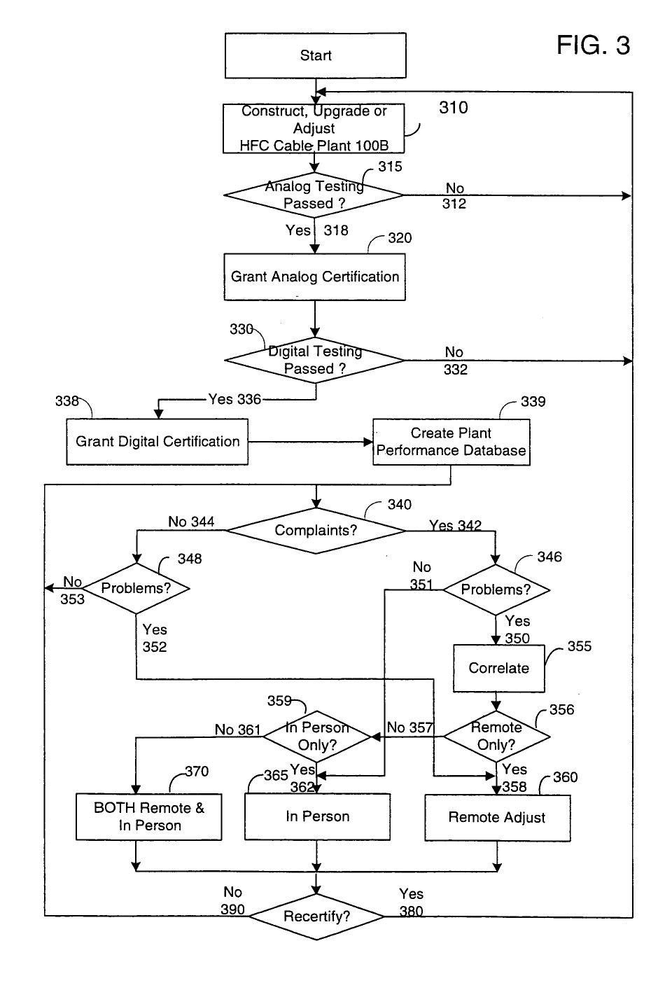

FIG. 3 is a simplified flow diagram of operational steps using analog and digital methods for certifying and maintaining an HFC cable plant. Beginning in step 310, an HFC cable plant 100B is newly constructed, upgraded or re-adjusted. Step 315 tests HFC cable plant 100B until granting analog certification. If in step 315 the tests fail to establish such certification, the process returns on “No” path 312 to step 310 and additional adjustments and upgrades are made. Once the step 315 analog testing is successfully passed, the process follows “Yes” path 318 and in step 320 grants analog certification for HFC cable plant 100B.

Next, step 330 digitally tests HFC cable plant 100B. Unlike the analog testing of step 315, digital testing is generally automated and thus does not require travel to various cable plant locations for testing purposes. The digital testing processes generally take advantage of the “smart” nature of the digital components used in building or upgrading HFC cable plant 100B. Thus components such as cable modems 394 (FIG. 2), digital amplifiers 150 (FIG. 2) and the like are configurable to automatically provide performance and status data to a central site.

In some embodiments in accordance with the invention, cable modems (CM's) 394 are coupled into a number of selected representative locations within the cable plant for digital testing purposes. At the cable plant's headend 180 (FIG. 2) a cable modem termination system 190 is coupled through the cable plant's network to each of the CM's 394. During digital testing, signals are sent through the CMTS 190 to each of the CM's 394 to query for status and other information. In response to these queries, each CM 394 sends a return signal to the CMTS 190 providing the requested information as well as a unique identifier portion or ID code. The ID code keys the response to the specific modem sending it. As responses are received, they are evaluated for establishing digital certification and to create a database that is useful for establishing a plant performance baseline. Advantageously, this automated process allows for requesting information, through the CMTS 190, from each CM 394 in a specific predetermined order and at a specific predetermined rate to enhance the testing process of step 330. Additionally, in some embodiments of the invention, the digital testing is initiated by signals sent to the CMTS 190 from a central, remote site coupled to the CMTS 190. As the digital testing of step 330 generally does not require sending personnel to various cable plant locations, it is well suited to the collection of data over a period of time, for example one or more days, to establish performance trends over the selected time period. This performance trend data can also be incorporated into the plant performance baseline. It will be understood that the digital testing of step 330 can also employ “smart” devices other than or in addition to CM's. For example, some embodiments of the invention use bi-directional amplifiers for testing HFC cable plant 100B in step 330. Other components that may be used include two-way digital set-top boxes and two-way network interface units.

If in step 330 the digital testing is failed, then the process returns on “No” path 332 to step 310 and additional adjustments and upgrades are made as required. If in step 330 the digital testing is passed, then the process continues on “Yes” path 336 to grant digital certification in step 338, and in step 339 to create the previously mentioned cable plant performance database. While FIG. 3 depicts the steps of analog testing and analog certification preceding those of digital testing and digital certification, this order is presented for illustrative purposes only. Analog and digital testing can proceed in any order, and often analog testing is concurrent with digital testing. Due to this flexibility in testing sequence, where testing for certification fails and the process returns on “No” path 312 or “No” path 332, some retesting in steps 315 or 330 may not be needed.

As previously mentioned, during the digital testing of step 330, “smart” devices such as cable modems (CM's 394) return ID codes to identify themselves. This ID code information can be correlated to physical location information to reduce the amount of testing required to grant digital certification. For example, where a first and a second CM 394 are positioned along a single cable run 125 (FIG. 2) with an amplifier 150 positioned therebetween, a good response from the second CM 394, furthest from the CMTS 190, indicates that the intermediate amplifier 150 is functioning properly. Therefore, some or all testing of that amplifier 150 can often be bypassed. Similarly, a poor or lost response from the second CM 394 indicates that a problem is located either at the second CM 394 or the amplifier 150. By requesting information from the suspect amplifier 150, the problem can be precisely identified and a repair or adjustment started. In some embodiments of the invention, it is possible to perform such digital testing by automated testing methods. That is to say, some digital testing processes of step 330 have a computing apparatus (not shown) and appropriate computing instructions to allow automatic polling of “smart” devices upon receipt of failed or suspect test data. Thus, devices located between a good device and a device reporting failed or suspect test data are polled until the actual failed or poorly performing device is identified and the problem with that device is determined. In addition, for some problems, repairs or adjustments are possible through remote reconfiguration of the failed or poorly performing device. A reconfiguration signal could be sent to the device in order to change various smart device settings. For example, settings such as the upstream transmit power, the upstream channel frequency, or the upstream pre-equalizer coefficients may be changed remotely.

After HFC cable plant 100B is certified and operating commercially, plant performance maintenance and timely responses to user complaints are essential. In FIG. 3, the process of maintaining HFC cable plant 100B is encompassed in step 340, step 346, step 348, step 355, step 356, step 359, step 360, step 365 and step 370. In step 340, user complaints are received and correlated with similar complaints. In step 346 and step 348, digital performance data is received from various “smart” devices within HFC cable plant 100B. Once received, this data is evaluated, for example by comparing the data to the plant performance baseline database created in step 339.

If there are current user complaints but no current problems indicated by the digital performance data, the maintenance process follows “No” path 351 and a technician is dispatched for field repair or maintenance in step 365.

If there are no current user complaints, but the digital performance data collected in step 348 indicates a problem through a warning, alarm, or message, the maintenance process follows “Yes” path 352 and remote adjustment or maintenance in step 360 is performed.

Advantageously, if problems are indicated by both user complaints and digital performance data, the maintenance process follows “Yes” path 350 and the complaints are correlated to the performance data in step 355. The correlation process of step 355 enhances identification of problems, both as to cause and location, which results in more rapid and more accurate maintenance responses. Thus, to affect the proper repair or adjustment procedures, step 356 determines whether the necessary adjustment can be done remotely. If remote adjustment only is necessary, “Yes” path 358 is followed to step 360 where remote adjustment occurs. If remote adjustment alone will not remedy the problems, “No” path 357 is followed to step 359, which determines whether the problems can be resolved only in person. If adjustment in person only is necessary, “Yes” path 362 is followed to step 365 where the adjustment is made in person. If the repairs cannot be accomplished solely by remote adjustment or by in person adjustment, “No” path 361 is followed to step 370 for both remote and in person adjustments.

Where the repairs or adjustments performed in step 360, step 365, or step 370 significantly change HFC cable plant 100B, recertification may be necessary. If so, the process follows “Yes” path 380 and recertification is begun. If not, “No” path 390 is followed and plant monitoring is continued.

It should be understood that due to the branched nature of an HFC cable plant, as depicted in FIG. 2, recertification might entail one or several branches and not necessarily the entire plant. In addition, in some embodiments of the invention, one portion of HFC cable plant 100B is undergoing a certification process while another portion is in commercial operation and is being monitored.

Certification and maintenance processes in accordance with the invention provide significant benefits over prior techniques. Rather than maintaining a cable plant using methodologies based primarily on user complaints, the FIG. 3 maintenance methodology of the invention employs both user feedback and digital performance data. In addition, this methodology advantageously provides for maintenance response based on user feedback or digital performance data that is used either singly, or combined and correlated with each other as well as with the plant performance baseline database created in step 339.

The above-described processes for digital testing, certification and monitoring also advantageously enable collecting and evaluating data generated at a remote site. In addition, where a cable plant operator has multiple cable plants, one remote site is capable of collecting and evaluating data for all plants. Thus, some embodiments of the invention provide a remote data collection and evaluation site.

Generally, this remote site encompasses a device for establishing a two-way communication channel to each cable plant. This communication channel is used for collecting data during the certification and monitoring processes, as well as sending signals to “smart” devices installed in the plant. The remote site also encompasses a computing apparatus and appropriate computer instructions or software.

In some embodiments of the invention, the software provides instructions-for evaluating data collected during testing for certification and/or during the plant monitoring processes. In some embodiments the software has instructions for creating a database from the collected data and establishing the previously mentioned cable plant performance baseline. In addition, some embodiments provide software instructions for comparing data collected during the monitoring processes with the performance baseline, and for issuing warnings, alarms and messages based on that comparison. Some embodiments of the invention also provide software instructions that automate data collection during both certification testing and plant monitoring processes. Thus these instructions provide for sending queries, as well as reconfiguration and adjustment instructions, to “smart” devices installed in the cable plant. Finally, in some embodiments of the invention, the ID portion of a device's response is automatically correlated to a physical location to provide for displaying a map of locations for HFC cable plant 100B on a display device at the remote site.

A detailed description of illustrative embodiments of the present invention has been presented. Various modifications or adaptations of the methods and specific structures described may have become apparent to those skilled in the art. Hence, these descriptions and drawings should not be considered in a limiting sense, as it is understood that the invention is limited only by the following claims.

1. A method for digitally testing a hybrid fiber coaxial cable plant, comprising:
sending a query to a plurality of cable modems the query including a request for information;
receiving a plurality of replies from the plurality of cable modems wherein a reply includes a unique identifier portion;
storing the plurality of replies in a database;
correlating each of the plurality of replies in the database to a specific cable modem using the unique identifier portion in each reply; and
developing a performance baseline report from data in the database.

2. A method for digitally testing a hybrid fiber coaxial cable plant, comprising:
digitally characterizing an upstream frequency band by querying a plurality of cable modems installed within the plant and receiving uniquely identified replies in response to each query;
identifying useful upstream frequencies from the digital frequency characterization wherein the identification corresponds to a predetermined performance baseline; and
restricting use of upstream frequencies to the identified useful upstream frequencies.

3. The method for digitally testing a hybrid fiber coaxial cable plant of claim 2 wherein digitally characterizing the upstream frequency band further comprises:
measuring the dynamic range of the hybrid fiber coaxial cable plant with a digital dynamic range analyzer;
identifying upstream paths where dynamic range is below a predetermined value; and
verifying upstream path alignment of the identified paths.

4. A system for digitally testing a hybrid fiber coaxial cable plant comprising:
means for sending a query to a plurality of cable modems, the query including a request for information;
means for receiving a plurality of replies from the plurality of cable modems wherein a reply includes a unique identifying portion;
means for storing the plurality of replies in a database, the plurality of replies being correlated to a specific cable modem using the unique identifier portion in each reply; and
means for developing a performance baseline report from data in the database.

5. A method for maintaining performance of a hybrid fiber coaxial cable system comprising:
establishing a performance baseline, the performance baseline reflecting at least one minimum performance parameter of a cable system;
requesting information from a plurality of cable system components coupled to the cable system wherein the acquired information corresponds to a particular cable system component;
determining whether a cable system component coupled to the cable system fails to meet the at least one minimum performance parameter of the cable system;
requesting further information from the cable system component coupled to the cable system wherein the cable system component fails to meet the at least one minimum performance parameter of the cable system; and
determining whether a maintenance response servicing the cable system component coupled to the cable system is appropriate based on, at least, a correlation of the at least one minimum performance parameter of the cable system component with the performance baseline.

6. The method of claim 1 wherein sending the query is automated.

7. The method of claim 1 wherein the receipt of the plurality of replies is automated.

8. The method of claim 1 wherein developing the performance baseline report comprises evaluation of packet error rate.

9. The method of claim 8 wherein the evaluation of packet error rate occurs over a spectrum of frequencies.

10. The method of claim 8 wherein the evaluation of packet error rate occurs over a spectrum of power levels.

11. The method of claim 1 wherein developing the performance baseline report comprises evaluation of nonlinearity and noise

12. The method of claim 1 wherein developing the performance baseline report comprises determining the upstream path of each cable modem-cable modem termination system.

13. The method of claim 1 wherein developing the performance baseline report comprises determining an optimal set of receive conditions.

14. The method of claim 1 wherein developing the performance baseline report comprises validating the alignment of reverse path amplifiers.

15. The method of claim 1 wherein developing the performance baseline report comprises identifying the nature of any physical impairments.

16. The method of claim 1 wherein developing the performance baseline report comprises evaluating signal-to-noise ratio.

17. The method of claim 1 wherein developing the performance baseline report comprises evaluating tilt and channel distortion.

18. The method of claim 1 wherein the request for information employs a simple network management protocol.

19. The method of claim 18 wherein a management information base provides information in response to the simple network management protocol.

20. The method of claim 1 wherein developing the performance baseline report comprises evaluating forward error correction rates.

21. The method of claim 2 wherein the upstream frequency band is approximately 5-50 MHz.

22. The method of claim 2 wherein the replies are at frequencies within the upstream frequency band.

23. The method of claim 5 further comprising:
triggering a notification message in response to determining whether a maintenance response is appropriate wherein the notification message is triggered in anticipation of the cable system not meeting the at least one performance parameter.

24. The method of claim 23 wherein the notification message is unique to a specific cable system component.

25. The method of claim 5 wherein determining whether a maintenance response is appropriate occurs remote from the cable system.
